(19) United States
(12) Patent Application Publication
(10) Pub. No.: US 2019/0262902 A1
(43) Pub. Date: Aug. 29, 2019

(54) STACKING DIE

(71) Applicants: NITTO DENKO CORPORATION, Ibaraki-shi, Osaka (JP); TOYO TANSO CO., LTD., Osaka-shi, Osaka (JP)

(72) Inventors: Takashi YAMAMOTO, Ibaraki-shi, Osaka (JP); Katsuya KUME, Ibaraki-shi, Osaka (JP); Toshiaki OKUNO, Ibaraki-shi, Osaka (JP); Hirofumi EBE, Ibaraki-shi, Osaka (JP); Takaaki KAKIKUBO, Osaka-shi, Osaka (JP); Hiroto MAKI, Osaka-shi, Osaka (JP); Tomoo TOKUNO, Osaka-shi, Osaka (JP); Ichiro FUJITA, Osaka-shi, Osaka (JP)

(21) Appl. No.: 16/342,620

(22) PCT Filed: Oct. 17, 2017
(86) PCT No.: PCT/JP2017/037557

§ 371 Date: Apr. 17, 2019

(30) Foreign Application Priority Data
Oct. 17, 2016 (JP) 2016-203243

(51) Int. Cl. B22F 3/14; B28B 3/02; B28B 7/26

(52) U.S. Cl. CPC B22F 3/14; B22F 2999/00; B28B 7/26; B28B 3/02

(57) ABSTRACT

A stacking die comprises a stacked multiple stacking plates and a side plate(s) which fixes the multiple stacking plates in a stacked state, wherein at least one or more processing object(s) is retained in a space(s) formed between the multiple stacking plates. Further, surfaces where the stacking plates and the side plate(s) abut each other are preferably tapered so that they form tapered shapes in a direction opposite to the approach direction of the side plate(s).

### CROSS REFERENCE TO RELATED APPLICATION

This application claims the priority of Japanese Patent Application No. 2016-203243, filed on Oct. 17, 2016, in the JPO (Japanese Patent Office). Further, this application is the National Phase Application of International Application No. PCT/JP2017/037557, filed on Oct. 17, 2017, which designates the United States and was published in Japan. Both of the priority documents are hereby incorporated by reference in their entireties.

### TECHNICAL FIELD

The embodiment relates to a stacking die used for press molding, heat treatment, sintering, and the like of ceramics and metals.

### BACKGROUND ART

Heretofore, there have been used, corresponding to the shape of a processing object, a press molding die, a heat treatment die, and a sintering die, respectively, for press molding, heat treatment, and sintering of metal powder, ceramic powder, or a green body obtained by mixing metal powder or ceramic powder and a binder followed by molding (hereinafter, the metal powder, ceramic powder, and green body are collectively referred to as a processing object).

For example, in a step of press molding a processing object, there is used a press molding die comprising a male die and a female die. There is known a method of molding the processing object by interposing the same between the male and female dies of the press molding die, and by pressing the same by applying a pressing pressure. Further, pressing of the processing object is performed using a hydraulic cylinder and a piston. For example, in Japanese Patent Laid-Open Publication No. 2000-79611, there is disclosed a method for performing press molding by retaining a processing object in a state interposed by a lower die, an upper die, a side die, and a flexible elastic member, and by moving the lower die to the upper die side by a hydraulic cylinder and a piston. According to this method, arrangement of the flexible elastic member enables the processing object to be isotropically pressed.

On the other hand, as an electrical current sintering die by which a heat treatment and sintering are performed while passing an electric current, Japanese Unexamined Utility Model Application Publication No. H3-111532, for example, discloses a method for performing a heat treatment and sintering by using a cylindrical outer die having a vertically passing hole at the center, and cylindrical upper and lower punches which are fitted in this hole, pressing the processing object vertically with the upper and lower punches, and passing an electric current at the same time.

### CITATION LIST

### Patent Document

### [Patent Literature 1]

Japanese Patent Laid-Open Publication No. 2000-79611

### [Patent Literature 2]

Japanese Unexamined Utility Model Application Publication No. H3-111532

### SUMMARY OF THE INVENTION

### Problems to be Solved by the Invention

In order to improve quality of a product, the above press molding die, heat treatment die, and sintering die require high dimensional accuracy. As a result, manufacturing of a die requires time and has been one of the factors of cost increase. Furthermore, when mounting a die on, for example, a press apparatus, a punch which presses a processing object has to be fixed to the press apparatus accurately and, moreover, accuracy has become necessary also for setting the processing object on the die. Therefore, a very long time has been spent on adjustment work when mounting the die on the press apparatus. Moreover, when treating processing objects having different shapes, the die has to be replaced and, thus, replacement of the die and accompanying adjustment work come to be performed frequently, causing worsening of work efficiency.

The embodiment has been made in order to solve the aforementioned conventional problems and aims to provide a stacking die comprising a stacked multiple plates, useful as a molding die, a heat treatment die, and a sintering die which can be set easily with good accuracy.

### Means for Solving the Problems

In order to achieve the aforementioned aims, a stacking die according to the embodiment comprises a stacked multiple stacking plates and a side plate which fixes the multiple stacking plates in a stacked state, wherein at least one processing object is retained in a space formed between the multiple stacking plates.

In addition, the number of the stacking plates may be 2 or 3 or more.

Further, the term “processing object” includes a green body, ceramic powder, metal powder, resin powder, and a slurry or the like obtained by mixing these with a dispersion medium such as water, an organic solvent, or the like and a binder, of which a material which needs to be subjected to molding, a heat treatment, and a sintering treatment corresponds to the processing object. Moreover, a mixture or a combination of the above-mentioned ceramic powder and the like is also included in the processing object.

Furthermore, in a stacking die according to an aspect of the embodiment, the side plate comprises at least one plate which fixes both edge parts of the stacking plates in a direction intersecting the stacking direction thereof.

Besides, a stacking die according to an aspect of the embodiment is characterized in that one or more punches are fitted in the space in which the processing object is retained.

Further, a stacking die according to an aspect of the embodiment comprises a through hole which penetrates through the punch and the stacking plates, wherein a fall-off preventing member is inserted into the through hole.

Furthermore, a stacking die according to an aspect of the embodiment is characterized in that the side plate is fixed to the stacking plates by making the side plate approach the stacking plates from a predetermined approach direction, and the surfaces where the stacking plates and the side plate abut each other are tapered so that they form tapered shapes in a direction opposite to the approach direction.

Besides, a stacking die according to an aspect of the embodiment is characterized in that at least a part thereof comprises a carbon-based material.

Moreover, a stacking die according to an aspect of the embodiment is characterized in that the carbon-based material is isotropic graphite.

### Advantageous Effects of Invention

According to the stacking die having the aforementioned configuration according to an aspect of the embodiment, it becomes possible to provide a molding die, a heat treatment die, and a sintering die which can be set easily with good accuracy. Further, a die having high dimensional accuracy can be manufactured inexpensively in comparison with a conventional one.

Furthermore, according to the stacking die according to an aspect of the embodiment, it becomes possible to fix a multiple stacking plates securely with a simple structure by one or more side plates.

Besides, according to the stacking die according to an aspect of the embodiment, it becomes possible, when pressing a processing object with a punch(es), to set the punch(es) easily with good accuracy.

Further, according to the stacking die according to an aspect of the embodiment, the punch(es) can be prevented from falling off from the stacking die. Especially when the processing object is pressed with a punch(esh) from a lower direction relative to the stacking die, the punch(es) can be prevented from falling off.

Furthermore, according to the stacking die according to an aspect of the embodiment, it becomes possible to make the side plate(s) approach the stacking plates easily in the approach direction to fix the same.

Besides, according to the stacking die according to an aspect of the embodiment, it becomes possible, by using a carbon material at least as a part of the stacking die, to convert the stacking die into one which has good processability and is light-weight.

Moreover, according to the stacking die according to an aspect of the embodiment, it becomes possible, by using isotropic graphite as the carbon material, to convert the stacking die into one which has good processability and is light-weight.

### BRIEF DESCRIPTION OF THE DRAWINGS

FIG. 1 is a perspective view showing the whole of a stacking die according to the present embodiment.

FIG. 2 is an exploded perspective view of the stacking die broken into respective parts.

FIG. 3 is a drawing illustrating a method for fixing the stacking plates by side plates.

FIG. 4 is a drawing illustrating a taper treatment of surfaces where the side plate and the stacking plates abut each other.

FIG. 5 is a drawing illustrating a method for calculating an optimum range of taper angle θ.

FIG. 6 is a drawing illustrating a method for calculating an optimum range of taper angle θ.

FIG. 7 is a drawing showing the stacking die of Examples.

FIG. 8 is a table showing respective dimension values of the stacking dies of Examples.

FIG. 9 is a table showing evaluation results of the stacking dies of Examples.

FIG. 10 is a drawing showing a modified example of the stacking die.

FIG. 11 is a drawing showing a modified example of the stacking die.

FIG. 12 is a drawing showing a modified example of the stacking die.

FIG. 13 is a drawing showing a modified example of the stacking die.

### DESCRIPTION OF THE EMBODIMENTS

Hereinafter, there will be described one embodiment in detail with reference to the drawings, in which there has been realized the stacking die according to the embodiment.

### [Configuration of Stacking Die]

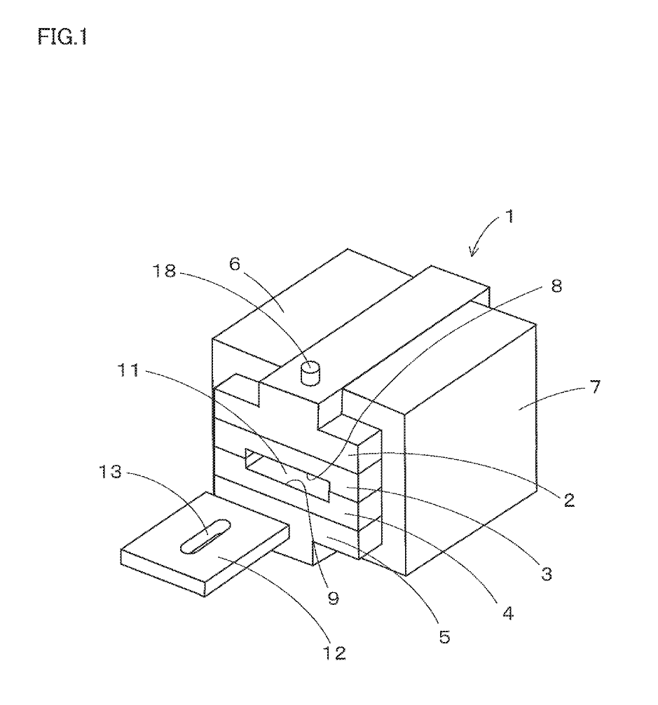

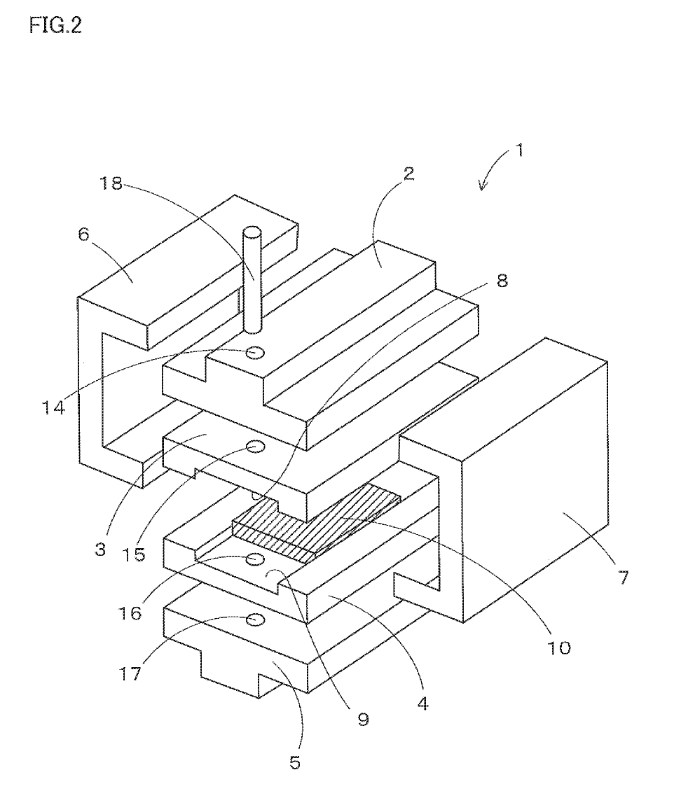

First, configuration of a stacking die 1 will be described. FIG. 1 is a perspective view showing the whole of the stacking die 1 according to the present embodiment, and FIG. 2 is an exploded perspective view of the stacking die 1 broken into parts. In addition, the stacking die 1 is a die used for press molding, heat treatment, and sintering of metal powder, ceramic powder, or a green body obtained by mixing metal powder or ceramic powder and a binder followed by molding (hereinafter, the metal powder, ceramic powder, and green body are collectively referred to as a processing object). That is, the stacking die 1 corresponds to a press molding die, a heat treatment die, and a sintering die.

As shown in FIG. 1, the stacking die 1 fundamentally comprises a stacked multiple stacking plates 2 to 5 and a pair of side plates 6 and 7 which fix the multiple stacking plates 2 to 5 in a stacked state. In the present embodiment, the number of the stacking plates 2 to 5 is set to 4, but the number of the stacking plates may be 2, 3 or 5 or more.

And, among the stacking plates 2 to 5, the stacking plate 3 and the stacking plate 4, which are located at the center, have recessed parts 8 and 9 on the surfaces which abut each other. And, by combining the recessed parts 8 and 9, there is formed a retaining space 11 for retaining a processing object 10. As the shape of the retaining space 11, it is possible to employ various shapes. For example, when the stacking die 1 is used to subject an already molded green body to a heat treatment or a sintering treatment, the shape of the retaining space 11 is formed corresponding to the shape of the green body. Further, when the stacking die 1 is used to mold metal powder and ceramic powder, the shape of the retaining space is formed corresponding to the shape of a molded body. In the present embodiment, the retaining space is formed, for example, into a cuboid shape.

Meanwhile, for the purpose of preventing a reaction between the processing object 10 and the stacking die 1, a mold release agent may be coated or a material having a mold release effect may be mounted on the surfaces of the recessed parts 8 and 9. Furthermore, in the present embodiment, both of the stacking plate 3 and the stacking plate 4, which are located at the center, have recessed parts 8 and 9 formed respectively, but the stacking die 1 may be configured such that the recessed part is formed on only either of the stacking plate 3 or the stacking plate 4. For example, it is possible that the recessed part is formed only on the stacking plate 3 and no recessed part is formed on the stacking plate 4.

Besides, the stacking die 1 comprises a punch 12 for pressing the processing object 10 retained in the retaining space 11. The shape of the punch 12 becomes a shape corresponding to the retaining space 11 and, in the present embodiment, the punch 12 becomes a cuboid shape. Further, the punch 12 is connected to a press machine which is not illustrated and, by operation of the press machine, the punch 12 moves parallel along the retaining space 11 and performs pressing of the processing object 10. Meanwhile, in FIG. 1, the punch 12 is arranged only in one direction relative to the retaining space 11 but, when pressing the processing object 10 from both sides, there is arranged a punch 12 in the opposite direction.

The stacking die 1 according to the embodiment can be used, for example, for sintering magnetic powder such as rare earth alloy powder and the like. In that case, used as the processing object 10 is especially a molded body of magnet powder, which is mainly composed of a resin binder and magnet powder and which has already been subjected to a binder removal treatment. When the stacking die 1 is used for such sintering, the sintering is preferably pressure sintering where pressure is applied to the molded body and pressing is performed by the punch 12. At that time, the pressure applied to the processing object 10 is not particularly limited but can be set, for example, to less than 50 MPa, preferably 25 MPa or less, more preferably 15 MPa or less. As for the lower limit, it can be set to, for example, 1 MPa or more, preferably 2 MPa or more, even more preferably 3 MPa or more.

Furthermore, in order to prevent the punch 12 from falling off from the stacking die 1, through holes 13 to 17 are formed in the punch 12 and the stacking plates 2 to 5. Each of the through holes 13 to 17 is configured so that the position thereof coincides with each other in a state where the stacking plates 2 to 5 are stacked and the punch 12 is fitted in the retaining space 11. Then, the punch 12 is supported so that it does not come off from the stacking die 1 by a rod-shaped fall-off preventing member 18 which is inserted into the through holes 13 to 17. In addition, when the processing object 10 is molded by pressing with the punch 12 and heat treated, the hole shape of the through hole 13 formed in the punch 12 is configured to be elliptic, with its longitudinal direction being the direction of movement of the punch 12 so that the punch 12 can move in the retaining space 11. Besides, the fall-off preventing member 18 may have a shape of a cylindrical bar or a square bar, and the shape thereof is not limited. For better handling, the fall-off preventing member 18 may be in a state protruding from the stacking die 1. Meanwhile, in the example shown in FIG. 1 and FIG. 2, the fall-off preventing member 18 is placed only for a punch 12 in one direction, but there may also be placed a fall-off preventing member 18 similarly for a punch 12 arranged in an opposite direction. Further, the fall-off preventing member 18 may be placed only for a punch 12 which, when the stacking die 1 is mounted on the press machine, is positioned at a lower part.

In addition, among the stacking plates 2 to 5, the through hole 17 formed in the stacking plate 5, positioned at the lowest part, does not necessarily need to be a hole which penetrates through the plate. Furthermore, the stacking plate 5 may be configured so that the through hole 17 is not formed therein. Even in that case, it is possible to prevent the punch 12 from falling off by the fall-off preventing member 18 penetrating through the through holes 13 to 16 of other stacking plates 2 to 4.

Besides, in the stacking die 1 according to the present embodiment, it is made possible to replace only a portion of the stacking plates 2 to 5 by having, as shown in FIG. 1 and FIG. 2, a four-layer structure of stacking plates 2 to 5. That is, in the stacking plates 2 to 5, the portions which contact the processing object 10 tend to generate deformation and distortion in comparison with other portions. In the present embodiment, there is no need to replace all of the stacking plates 2 to 5, and cost reduction becomes possible by replacing only the stacking plates 3 and 4 which contact the processing object 10.

Further, in the present embodiment, the stacking die 1 comprises a carbon-based material, more specifically, isotropic graphite. However, it is possible to select a material to be used suitably. For example, it is possible to use: a graphite material, a carbon fiber-reinforced carbon composite material, glassy carbon and pyrolytic carbon, and the like; and a material using these as a base material, such as, for example, a SiC-coated graphite material in which SiC is coated on the surface of a graphite material, a pyrolytic carbon-coated graphite material in which pyrolytic carbon is coated on the surface of a graphite material, and the like. Besides, it is not necessary that all members are of the same material, and a part of the members (for example, the punch 12 or the fall-off preventing member 18) may be of a different material.

Furthermore, there will be described an example of a general manufacturing method when manufacturing the stacking die 1 with, for example, a graphite material.

First, a carbon molded body is heated up to 800° C. to 1000° C. in a firing furnace, and is fired by dispersing and evaporating an easily volatile component contained in the binder and the like. Next, a fired body is taken out and is graphitized by heating up to 3000° C. in a graphitizing furnace such as an Acheson-type furnace, a Castner-type furnace, and a dielectric furnace (for example, Japanese Patent Laid-Open Publication No. S57-166305, 166306, 166307, and 166308).

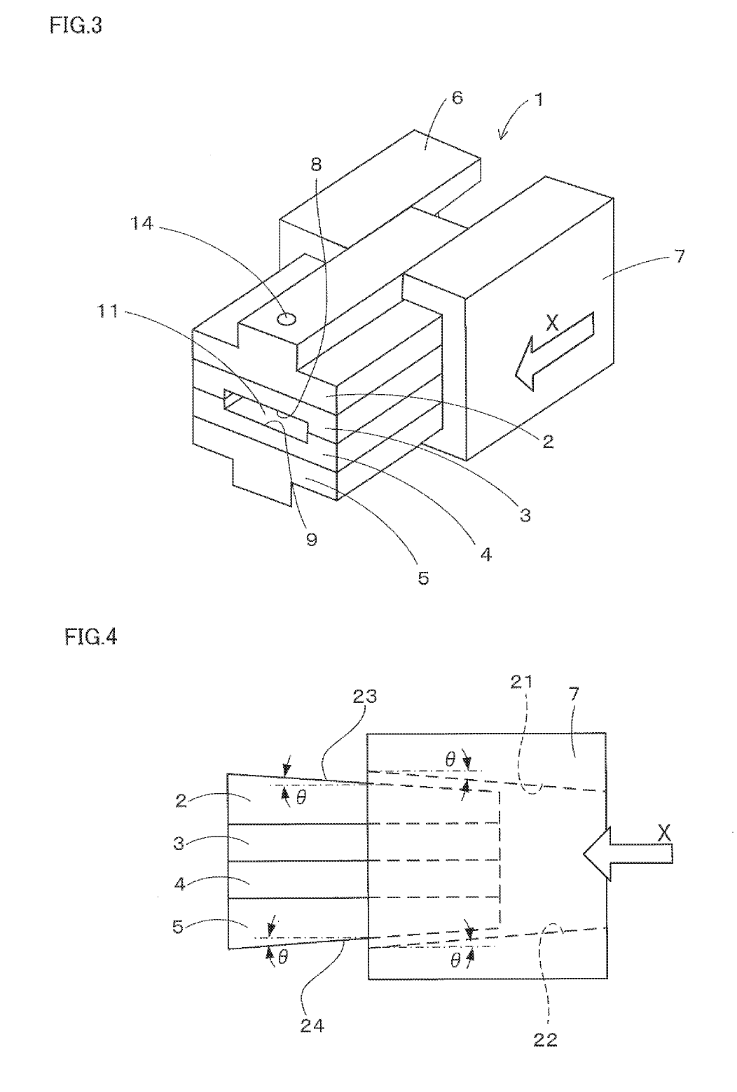

On the other hand, the side plates 6 and 7 are, as shown in FIG. 3 and FIG. 4, made to approach the stacking plates 2 to 5 in a stacked state from a predetermined approach direction X, and thereby the stacking plates 2 to 5 and the side plates 6 and 7 are engaged to fix the stacking plates 2 to 5. Specifically, both edge parts of the stacking plates 2 to 5 are fixed in a direction intersecting the stacking direction of the stacking plates 2 to 5 (vertical direction in FIG. 3 and FIG. 4) and in a direction different from the approach direction of the punch 12.

Further, the surfaces where the stacking plates 2 and 5 and the side plates 6 and 7 abut each other are tapered so that they form tapered shapes in a direction opposite to the approach direction X. Specifically, as shown in FIG. 4, the surface 21 of the side plate 7, which contacts the stacking plate 2, is inclined relative to the horizontal direction (approach direction X) by an angle θ. Likewise, the surface 22 of the side plate 7, which contacts the stacking plate 5, is inclined relative to the horizontal direction (approach direction X) by an angle θ. Moreover, the surface 23 of the stacking plate 2, which contacts the side plate 7, is inclined relative to the horizontal direction (approach direction X) by an angle θ. Likewise, the surface 24 of the stacking plate 5, which contacts with the side plate 7, is inclined relative to the horizontal direction (approach direction X) by an angle θ. As a result, the surfaces 21 to 24 form tapered shapes in a direction opposite to the approach direction X (that is, a distance between the surfaces 21 and 22 becomes gradually larger along the approach direction X, and a distance between the surfaces 23 and 24 becomes gradually larger along the approach direction X). As a result, it becomes possible to fix the side plates 6 and 7 easily to the stacking plates 2 to 5. Meanwhile, in the present embodiment, the angles of the surfaces 21 to 24 are all set to the same angle, but the surfaces 21 and 23 and the surfaces 22 and 24 may be set to different angles.

However, regarding the taper angle θ, it is required that frictional force generated on respective abutting surfaces 21 to 24 of the stacking plates 2 to 5 and the side plates 6 and 7 becomes not less than a value which can fix the stacking plates and the side plates.

Specifically, the frictional force generated on respective abutting surfaces 21 to 24 of the stacking plates 2 to 5 and the side plates 6 and 7 is desirably larger than sliding force of the side plates 6 and 7.

For example, the taper angle θ desirably satisfies the following conditions.

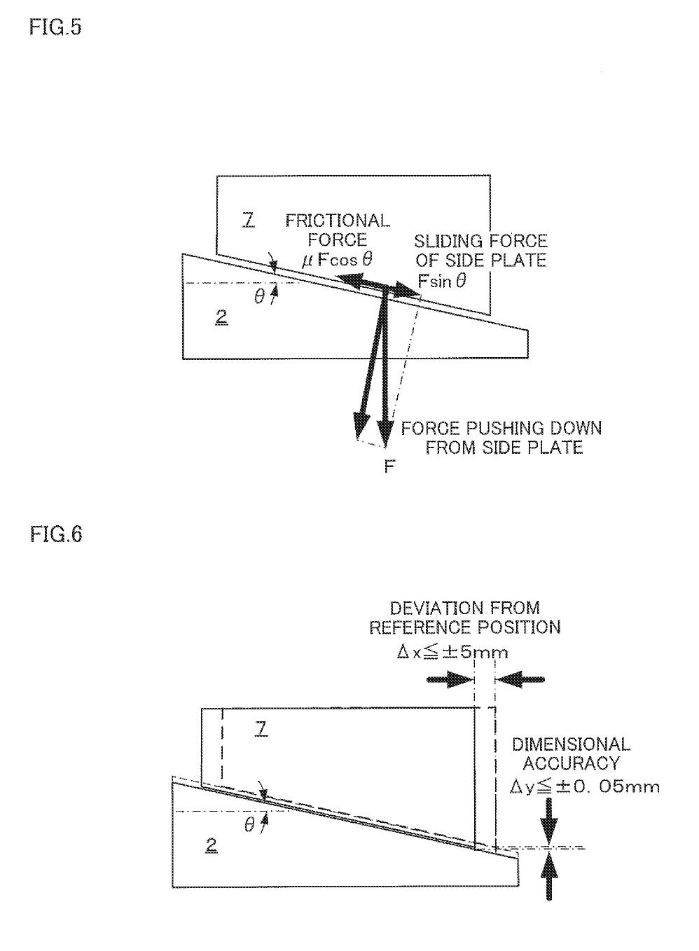

As shown in FIG. 5, for the frictional force generated on respective abutting surfaces 21 to 24 of the stacking plates 2 to 5 and the side plates 6 and 7 to become not less than a value which can fix the stacking plates and the side plates, satisfaction of the following formulas (1) and (2) is the condition.

F×sin θμF×cos θ (1)

μ≥tan θ (2)

In addition, F is force to push down the stacking plates 2 to 5, and μ is a coefficient of static friction.

Here, a coefficient of static friction, μ, of a graphite material, which can be used at a high temperature as a raw material of a die, is generally 0.1 to 0.2 when the graphite material is finished smooth. Therefore, the following formula (3) is derived as a condition for the taper angle θ.

θ≤5.7°−11.3° (3)

The above angle range becomes a preferable range of taper angle θ, at which the stacking plates 2 to 5 can be fixed by the side plates 6 and 7. Meanwhile, when the surface of the graphite material is made rough in order to increase the coefficient of static friction of the surface, abrasion powder is generated by rubbing of graphite with each other at the tapered portion. Therefore, the tapered portion needs to be finished as smooth as possible.

Further, as shown in FIG. 6, when the side plates 6 and 7 are fixed to the stacking plates 2 to 5 within this dimensional accuracy, positions of the side plates 6 and 7 preferably fall within a deviation of ±5 mm from an expected reference position. Moreover, dimensional accuracy of the stacking plates 2 to 5 and the side plates 6 and 7 in a stacked state is preferably ±0.05 mm or less, respectively, from the standpoint of die accuracy required and productivity. When the dimensional accuracy surpasses this range, the dimension of the stacking die becomes large to make the die hard to handle and, at the same time, material cost and processing cost increase. Specifically, satisfaction of the following formulas (4) to (6) is the condition.

Δy/Δx≤tan θ (4)

Δx±5 mm (5)

Δy≤±0.05 mm (6)

Then, from the formulas (4) to (6), the following formula (7) is derived as a condition for the taper angle θ.

θ≥0.57° (7)

Then, from the formula (3) and the formula (7), a range of the taper angle θ is finally calculated.

0.57°≤θ≤5.7°

And, referring to the range of taper angle θ obtained from the above calculations, stacking dies were prepared with various taper angles θ, and tests were repeated to verify an optimum taper angle.

### Example 1

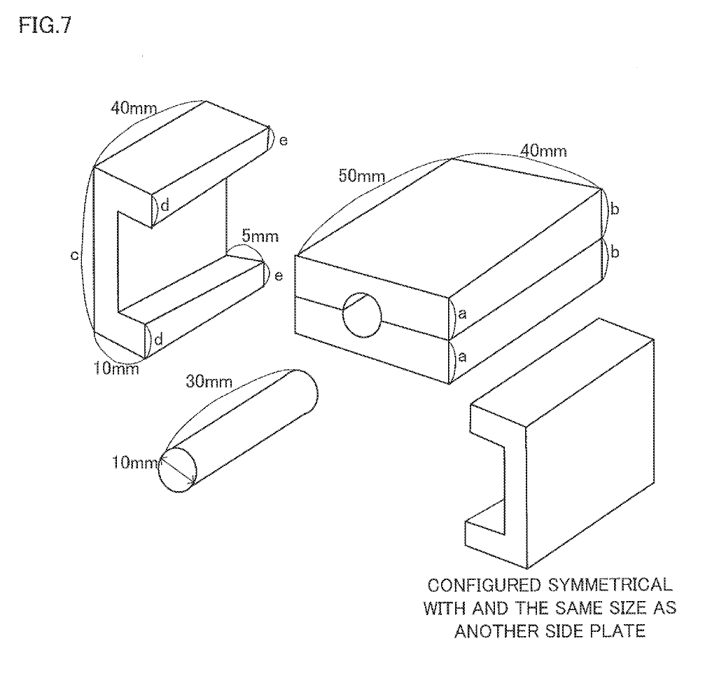

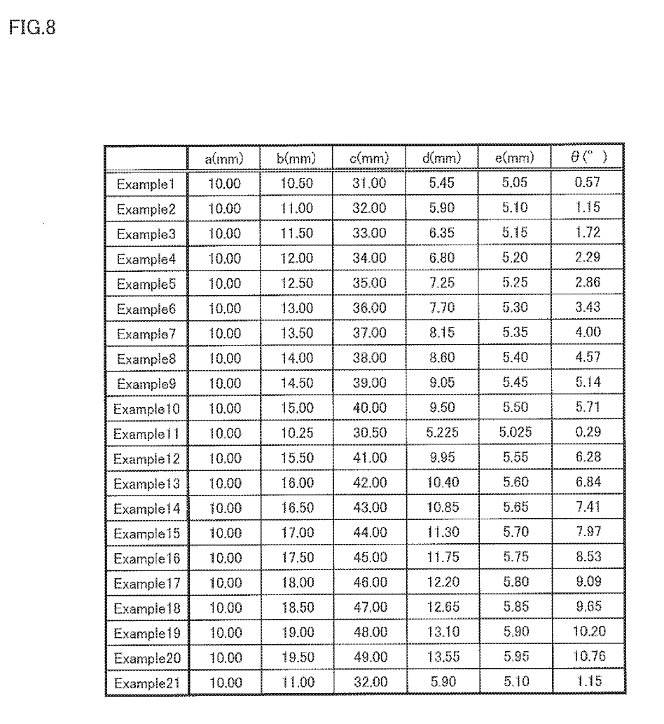

Meanwhile, in Example 1, stacking plates were, as shown in FIG. 7, stacked in two layers and a retaining space to retain a processing object and a punch to press the processing object were formed into cylindrical shapes. Further, the stacking plates were fixed in a stacked state at left and right edge parts by a pair of side plates. The pair of side plates are configured to have a symmetrical shape and the same size. And, in order to make the taper angle θ equal to 0.57°, the dimensions of a, b, c, d, and e in FIG. 7 were set, as noted in FIG. 8, to 10.00 mm, 10.50 mm, 31.00 mm, 5.45 mm, and 5.05 mm, respectively, and each member which constitutes the stacking die 1 was prepared using isotropic graphite material (Isotropic Graphite ISO-68, produced by Toyo Tanso Co., Ltd.) having a density of 1.82 g/cm3, flexural strength of 76 MPa, compression strength of 172 MPa, and tensile strength of 54 MPa. Furthermore, each member was manufactured so that surface roughness Ra became 3 μm or less. And, the stacking plates were stacked and fixed by pushing the side plates with force of 100N. The processing object was tungsten powder having a particle size of 0.5 μm, and 8 g thereof was charged between punches of φ 10 mm Subsequently, a load of 20 MPa was applied between the punches of the above stacking die by an SPS apparatus (spark plasma sintering apparatus).

### (Result)

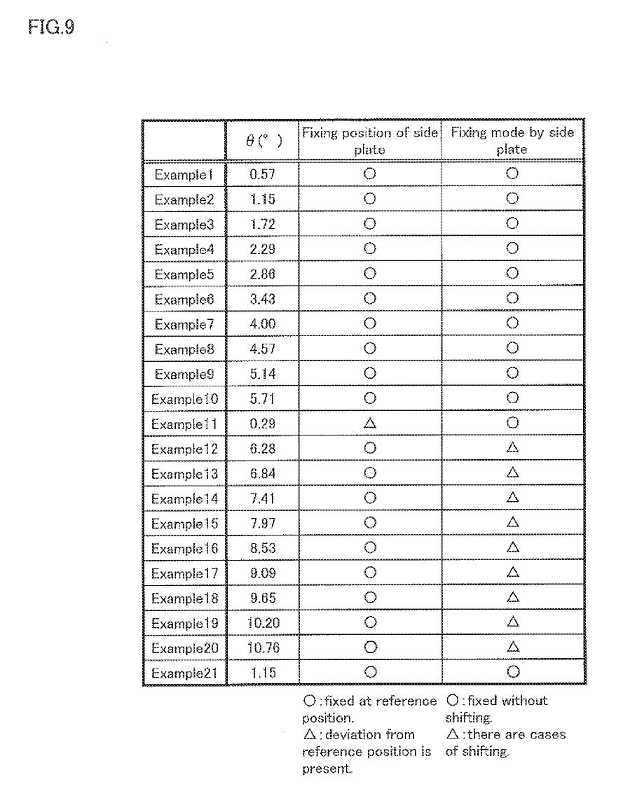

As shown in FIG. 9, the side plates were fixed at a reference position (central position), and the processing object could be pressed without problems. Next, an electric current was passed between the punches, and the processing object was sintered by performing pulse electric current sintering for 5 minutes under vacuum. Thus, a tungsten sintered body could be prepared.

### Example 2

Operations similar to those of Example 1 were performed except that, in order to make the taper angle θ equal to 1.15°, the dimensions of a, b, c, d, and e in FIG. 7 were set, as noted in FIG. 8, to 10.00 mm, 11.00 mm, 32.00 mm, 5.90 mm, and 5.10 mm, respectively.

### (Result)

As shown in FIG. 9, the side plates were fixed at a reference position (central position), and the processing object could be pressed without problems. Next, an electric current was passed between the punches, and the processing object was sintered by performing pulse electric current sintering for 5 minutes under vacuum. Thus, a tungsten sintered body could be prepared.

### Example 3

Operations similar to those of Example 1 were performed except that, in order to make the taper angle θ equal to 1.72°, the dimensions of a, b, c, d, and e in FIG. 7 were set, as noted in FIG. 8, to 10.00 mm, 11.50 mm, 33.00 mm, 6.35 mm, and 5.15 mm, respectively.

### (Result)

As shown in FIG. 9, the side plates were fixed at a reference position (central position), and the processing object could be pressed without problems. Next, an electric current was passed between the punches, and the processing object was sintered by performing pulse electric current sintering for 5 minutes under vacuum. Thus, a tungsten sintered body could be prepared.

### Example 4

Operations similar to those of Example 1 were performed except that, in order to make the taper angle θ equal to 2.29°, the dimensions of a, b, c, d, and e in FIG. 7 were set, as noted in FIG. 8, to 10.00 mm, 12.00 mm, 34.00 mm, 6.80 mm, and 5.20 mm, respectively.

### (Result)

As shown in FIG. 9, the side plates were fixed at a reference position (central position), and the processing object could be pressed without problems. Next, an electric current was passed between the punches, and the processing object was sintered by performing pulse electric current sintering for 5 minutes under vacuum. Thus, a tungsten sintered body could be prepared.

### Example 5

Operations similar to those of Example 1 were performed except that, in order to make the taper angle θ equal to 2.86°, the dimensions of a, b, c, d, and e in FIG. 7 were set, as noted in FIG. 8, to 10.00 mm, 12.50 mm, 35.00 mm, 7.25 mm, and 5.25 mm, respectively.

### (Result)

As shown in FIG. 9, the side plates were fixed at a reference position (central position), and the processing object could be pressed without problems. Next, an electric current was passed between the punches, and the processing object was sintered by performing pulse electric current sintering for 5 minutes under vacuum. Thus, a tungsten sintered body could be prepared.

### Example 6

Operations similar to those of Example 1 were performed except that, in order to make the taper angle θ equal to 3.43°, the dimensions of a, b, c, d, and e in FIG. 7 were set, as noted in FIG. 8, to 10.00 mm, 13.00 mm, 36.00 mm, 7.70 mm, and 5.30 mm, respectively.

### (Result)

As shown in FIG. 9, the side plates were fixed at a reference position (central position), and the processing object could be pressed without problems. Next, an electric current was passed between the punches, and the processing object was sintered by performing pulse electric current sintering for 5 minutes under vacuum. Thus, a tungsten sintered body could be prepared.

### Example 7

Operations similar to those of Example 1 were performed except that, in order to make the taper angle θ equal to 4.00°, the dimensions of a, b, c, d, and e in FIG. 7 were set, as noted in FIG. 8, to 10.00 mm, 13.50 mm, 37.00 mm, 8.15 mm, and 5.35 mm, respectively.

### (Result)

As shown in FIG. 9, the side plates were fixed at a reference position (central position), and the processing object could be pressed without problems. Next, an electric current was passed between the punches, and the processing object was sintered by performing pulse electric current sintering for 5 minutes under vacuum. Thus, a tungsten sintered body could be prepared.

### Example 8

Operations similar to those of Example 1 were performed except that, in order to make the taper angle θ equal to 4.57°, the dimensions of a, b, c, d, and e in FIG. 7 were set, as noted in FIG. 8, to 10.00 mm, 14.00 mm, 38.00 mm, 8.60 mm, and 5.40 mm, respectively.

### (Result)

As shown in FIG. 9, the side plates were fixed at a reference position (central position), and the processing object could be pressed without problems. Next, an electric current was passed between the punches, and the processing object was sintered by performing pulse electric current sintering for 5 minutes under vacuum. Thus, a tungsten sintered body could be prepared.

### Example 9

Operations similar to those of Example 1 were performed except that, in order to make the taper angle θ equal to 5.14°, the dimensions of a, b, c, d, and e in FIG. 7 were set, as noted in FIG. 8, to 10.00 mm, 14.50 mm, 39.00 mm, 9.05 mm, and 5.45 mm, respectively.

### (Result)

As shown in FIG. 9, the side plates were fixed at a reference position (central position), and the processing object could be pressed without problems. Next, an electric current was passed between the punches, and the processing object was sintered by performing pulse electric current sintering for 5 minutes under vacuum. Thus, a tungsten sintered body could be prepared.

### Example 10

Operations similar to those of Example 1 were performed except that, in order to make the taper angle θ equal to 5.71°, the dimensions of a, b, c, d, and e in FIG. 7 were set, as noted in FIG. 8, to 10.00 mm, 15.00 mm, 40.00 mm, 9.50 mm, and 5.50 mm, respectively.

### (Result)

As shown in FIG. 9, the side plates were fixed at a reference position (central position), and the processing object could be pressed without problems. Next, an electric current was passed between the punches, and the processing object was sintered by performing pulse electric current sintering for 5 minutes under vacuum. Thus, a tungsten sintered body could be prepared.

### Example 11

Operations similar to those of Example 1 were performed except that, in order to make the taper angle θ equal to 0.29°, the dimensions of a, b, c, d, and e in FIG. 7 were set, as noted in FIG. 8, to 10.00 mm, 10.25 mm, 30.50 mm, 5.225 mm, and 5.025 mm, respectively.

### (Result)

As shown in FIG. 9, when pushing the side plates to the tapered portion of the stacking plates, the stacking plates were fixed at a position about 6 mm deep from a reference position (central position). In this situation, the processing object was not fixed sufficiently by the side plates. However, pressing and an electric current test could be performed in allowable ranges.

### Example 12

Operations similar to those of Example 1 were performed except that, in order to make the taper angle θ equal to 6.28°, the dimensions of a, b, c, d, and e in FIG. 7 were set, as noted in FIG. 8, to 10.00 mm, 15.50 mm, 41.00 mm, 9.95 mm, and 5.55 mm, respectively.

### (Result)

As shown in FIG. 9, the side plates were fixed at a reference position (central position). However, when a load of 10 MPa was applied to the punch, there were cases when the tapered portions of the side plates, fixing the stacking plates, shifted. However, pressing and an electric current test could be performed in allowable ranges.

### Example 13

Operations similar to those of Example 1 were performed except that, in order to make the taper angle θ equal to 6.84°, the dimensions of a, b, c, d, and e in FIG. 7 were set, as noted in FIG. 8, to 10.00 mm, 16.00 mm, 42.00 mm, 10.40 mm, and 5.60 mm, respectively.

### (Result)

As shown in FIG. 9, the side plates were fixed at a reference position (central position). However, when a load of 10 MPa was applied to the punch, there were cases when the tapered portions of the side plates, fixing the stacking plates, shifted. However, pressing and an electric current test could be performed in allowable ranges.

### Example 14

Operations similar to those of Example 1 were performed except that, in order to make the taper angle θ equal to 7.41°, the dimensions of a, b, c, d, and e in FIG. 7 were set, as noted in FIG. 8, to 10.00 mm, 16.50 mm, 43.00 mm, 10.85 mm, and 5.65 mm, respectively.

### (Result)

As shown in FIG. 9, the side plates were fixed at a reference position (central position). However, when a load of 10 MPa was applied to the punch, there were cases when the tapered portions of the side plates, fixing the stacking plates, shifted. However, pressing and an electric current test could be performed in allowable ranges.

### Example 15

Operations similar to those of Example 1 were performed except that, in order to make the taper angle θ equal to 7.97°, the dimensions of a, b, c, d, and e in FIG. 7 were set, as noted in FIG. 8, to 10.00 mm, 17.00 mm, 44.00 mm, 11.30 mm, and 5.70 mm, respectively.

### (Result)

As shown in FIG. 9, the side plates were fixed at a reference position (central position). However, when a load of 10 MPa was applied to the punch, there were cases when the tapered portions of the side plates, fixing the stacking plates, shifted. However, pressing and an electric current test could be performed in allowable ranges.

### Example 16

Operations similar to those of Example 1 were performed except that, in order to make the taper angle θ equal to 8.53°, the dimensions of a, b, c, d, and e in FIG. 7 were set, as noted in FIG. 8, to 10.00 mm, 17.50 mm, 45.00 mm, 11.75 mm, and 5.75 mm, respectively.

### (Result)

As shown in FIG. 9, the side plates were fixed at a reference position (central position). However, when a load of 10 MPa was applied to the punch, there were cases when the tapered portions of the side plates, fixing the stacking plates, shifted. However, pressing and an electric current test could be performed in allowable ranges.

### Example 17

Operations similar to those of Example 1 were performed except that, in order to make the taper angle θ equal to 9.09°, the dimensions of a, b, c, d, and e in FIG. 7 were set, as noted in FIG. 8, to 10.00 mm, 18.00 mm, 46.00 mm, 12.20 mm, and 5.80 mm, respectively.

### (Result)

As shown in FIG. 9, the side plates were fixed at a reference position (central position). However, when a load of 10 MPa was applied to the punch, there were cases when the tapered portions of the side plates, fixing the stacking plates, shifted. However, pressing and an electric current test could be performed in allowable ranges. Generation of abrasion powder was confirmed at the tapered portions.

### Example 18

Operations similar to those of Example 1 were performed except that, in order to make the taper angle θ equal to 9.65°, the dimensions of a, b, c, d, and e in FIG. 7 were set, as noted in FIG. 8, to 10.00 mm, 18.50 mm, 47.00 mm, 12.65 mm, and 5.85 mm, respectively.

### (Result)

As shown in FIG. 9, the side plates were fixed at a reference position (central position). However, when a load of 10 MPa was applied to the punch, there were cases when the tapered portions of the side plates, fixing the stacking plates, shifted. However, pressing and an electric current test could be performed in allowable ranges. Generation of abrasion powder was confirmed at the tapered portions.

### Example 19

Operations similar to those of Example 1 were performed except that, in order to make the taper angle θ equal to 10.20°, the dimensions of a, b, c, d, and e in FIG. 7 were set, as noted in FIG. 8, to 10.00 mm, 19.00 mm, 48.00 mm, 13.10 mm, and 5.90 mm, respectively.

### (Result)

As shown in FIG. 9, the side plates were fixed at a reference position (central position). However, when a load of 10 MPa was applied to the punch, there were cases when the tapered portions of the side plates, fixing the stacking plates, shifted. However, pressing and an electric current test could be performed in allowable ranges. Generation of abrasion powder was confirmed at the tapered portions.

### Example 20

Operations similar to those of Example 1 were performed except that, in order to make the taper angle θ equal to 10.76°, the dimensions of a, b, c, d, and e in FIG. 7 were set, as noted in FIG. 8, to 10.00 mm, 19.50 mm, 49.00 mm, 13.55 mm, and 5.95 mm, respectively.

### (Result)

As shown in FIG. 9, the side plates were fixed at a reference position (central position). However, when a load of 10 MPa was applied to the punch, there were cases when the tapered portions of the side plates, fixing the stacking plates, shifted. However, pressing and an electric current test could be performed in allowable ranges. Generation of abrasion powder was confirmed at the tapered portions.

### Example 21

By using the same stacking die as in Example 2, there was placed, as a processing object, 12.9 g of a molded body obtained from a mixture of 4 parts by weight of polyisobutylene (binder) and 100 parts by weight of Nd/Fe/B magnet powder in the retaining space, and the processing object was calcined at 500° C. for 2 hours under a hydrogen atmosphere to remove the binder.

Next, punches were set and, by an SPS apparatus (spark plasma sintering apparatus), a load of 5 MPa was applied between the punches in the stacking die. An electric current was passed between the punches. and the processing object was sintered at 950° C. for 15 minutes by performing pulse electric current sintering under vacuum to prepare a Nd magnet sintered body.

### (Result)

In the same manner as in Example 2, the side plates were fixed at a reference position (central position), and the processing object could be pressed without problems. Next, an electric current was passed between the punches, and the processing object was sintered for 5 minutes by performing pulse electric current sintering under vacuum. Thus, a sintered body of Nd magnet powder could be prepared. The sintered body obtained could be sintered in a desired shape without cracks and the like.

As seen above, it is recognized that there is an optimum range in the taper angle θ, and the range is 5.8° or less, more preferably 0.5° or more and 5.8° or less.

As described above, the stacking die 1 according to the embodiment comprises a stacked multiple stacking plates and side plates which fix the multiple stacking plates in a stacked state, wherein at least one or more processing object(s) is retained in a space(s) formed between the multiple stacking plates. Therefore, it becomes possible to provide a molding die, a heat treatment die, and a sintering die which can be set easily with good accuracy. Further, a die having high dimensional accuracy can be manufactured inexpensively in comparison with a conventional one.

### Modified Example

In addition, the embodiment is not limited to the aforementioned Examples, and it is a matter of course that various improvements and modifications are possible, as long as they do not deviate from the gist of the embodiment.

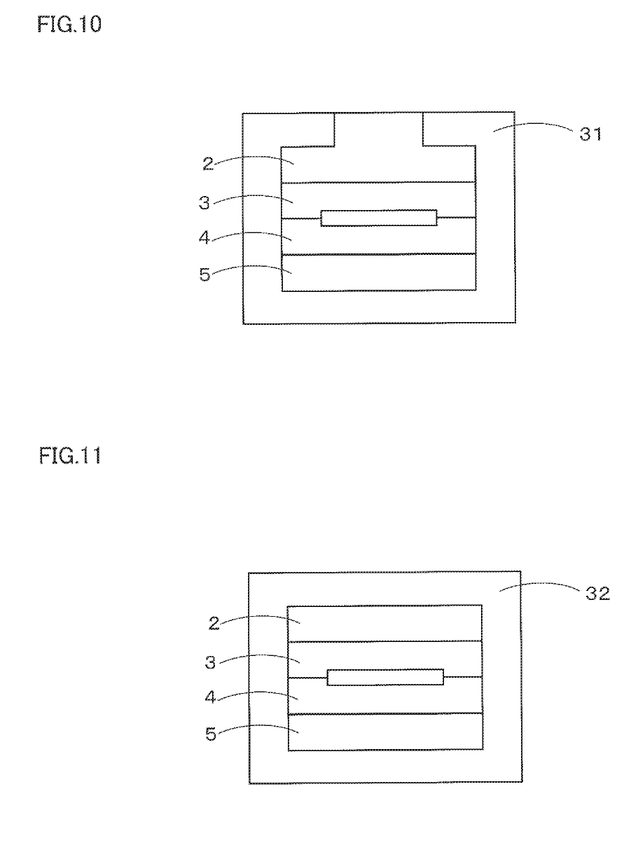

For example, in the present embodiment, the side plates 6 and 7 are configured, as shown in FIG. 1, to be a pair of plates which fix both edge parts of the stacking plates 2 to 5 in a direction intersecting the stacking direction thereof. However, the shape of the side plate may be changed to other shapes as long as it can fix the stacking plates 2 to 5. For example, as shown in FIG. 10, the stacking plates 2 to 5 may be fixed by one side plate 31, the cross section of which has a U-shape. Further, as shown in FIG. 11, the stacking plates 2 to 5 may be fixed by one side plate 32, the cross section of which has a square shape. Meanwhile, in the cases shown in FIG. 10 and FIG. 11 also, the surfaces where the stacking plates 2 and 5 and side plates 31 or 32 abut each other are preferably tapered so that they form tapered shapes in a direction opposite to the approach direction. However, in configurations shown in FIG. 10 and FIG. 11, higher dimensional accuracy is required to combine the stacking plates 2 to 5 with side plate 31 or 32 than with the pair of side plates 6 and 7 shown in FIG. 1.

Further, in the present embodiment, the stacking plates 2 to 5 may be configured to be fixed by either the side plate 6 or the side plate 7.

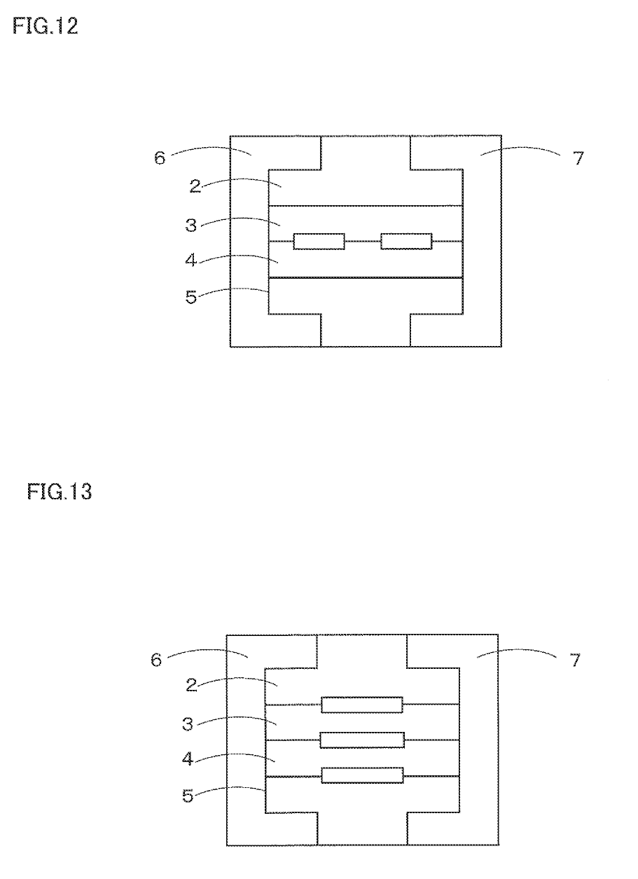

Furthermore, in the above Examples, one stacking die 1 is configured, as is shown in FIG. 1, to retain one processing object, but it is also possible that one stacking die 1 is configured to retain a plurality of processing objects. For example, as shown in FIG. 12, it is possible to form a plurality of retaining spaces to retain the processing objects by forming a plurality of recessed parts on abutting surfaces of a stacking plate 3 and a stacking plate 4. On the other hand, as shown in FIG. 13, it is possible to form a plurality of retaining spaces to retain the processing objects by forming recessed parts also on abutting surfaces of a stacking plate 2 and a stacking plate 3 and on abutting surfaces of a stacking plate 4 and a stacking plate 5. In addition, corresponding to the number of retaining spaces, the number of punches need to be increased. And, when the stacking die is configured as shown in FIG. 12 and FIG. 13, treatments (molding, heat treatment, sintering, and the like) of many processing objects can be performed simultaneously and, therefore, it becomes possible to increase manufacturing efficiency.

### INDUSTRIAL APPLICABILITY

According to the present embodiment, it is possible to provide a die inexpensively, which is used for press molding, heat treatment, and the like with good accuracy and operability. The die is expected to develop in future in the field of heat treatment, sintering, and the like, where ceramics and metal are used as raw materials. Industrial applicability of the die is very high.

### REFERENCE SIGNS LIST

1. Stacking die
2-5. Stacking plate
6, 7. Side plate
8, 9. Recessed part
10. Processing object
11. Retaining space
12. Punch
13-17. Through hole
18. Fall-off preventing member
21-24. Tapered surface

1. A stacking die comprising a stacked multiple stacking plates and a side plate which fixes the multiple stacking plates in a stacked state, wherein at least one processing object is retained in a space formed between the multiple stacking plates.

2. The stacking die according to claim 1, wherein the side plate comprises at least one plate which fixes both edge parts of the stacking plates in a direction intersecting the stacking direction thereof.

3. The stacking die according to claim 1, wherein one or more punches are fitted in the space in which the processing object is retained.

4. The stacking die according to claim 1, comprising a through hole which penetrates through the punch and the stacking plates, wherein a fall-off preventing member is inserted into the through hole.

5. The stacking die according to claim 1, wherein the side plate is fixed to the stacking plates by making the side plate approach the stacking plates from a predetermined approach direction, wherein the surfaces where the stacking plates and the side plate abut each other are tapered so that they form tapered shapes in a direction opposite to the approach direction.

6. The stacking die according to claim 1, wherein at least a part thereof comprises a carbon-based material.

7. The stacking die according to claim 6, wherein the carbon-based material is isotropic graphite.
